(19) United States
(12) Patent Application Publication
(10) Pub. No.: US 2001/0022109 A1
(43) Pub. Date: Sep. 20, 2001

(54) Multiaxial robot, particularly for use in the food sector

(76) Inventors: Michael Wenninger, Halesowen (GB); Koorosh Khodabandehloo, Culmstock (GB)

Correspondence Address: McGLEW AND TUTTLE, P.C., SCARBOROUGH STATION, SCARBOROUGH, NY, 10510-0827, US

(21) Appl. No.: 09/773,720

(22) Filed: Feb. 1, 2001

(30) Foreign Application Priority Data
Feb. 2, 2000 (DE) 100 04 519.7

(51) Int. Cl. F16J 15/16

(52) U.S. Cl. 74/18; 414/680; 74/490.01

(57) ABSTRACT

A multiaxial robot with a frame and a structure with at least one robot arm having a robot hand is proposed, more particularly for use in the food sector. The robot has an envelope surrounding it in a substantially gas and liquid-tight manner and which has a flexible construction at least on a section facing the robot hand, whilst at least partly exposing a tool and sealingly engages on the transition area between the robot hand and the tool. According to a preferred construction, the envelope is constructed in the manner of a cabin receiving at least the robot frame and provided with at least one passage for the robot arm, the passage being connected about its circumference with a flexible membrane tightly engaging on the robot hand.

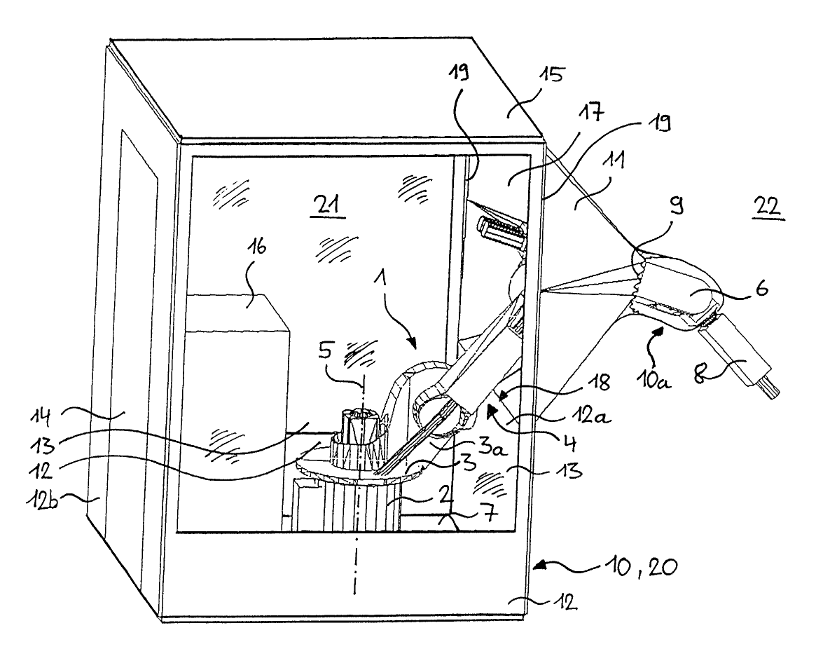

### FIELD OF THE INVENTION

The invention relates to a multiaxial robot having a frame and a structure with at least one robot arm having a robot hand, particularly for use in the food sector.

### BACKGROUND OF THE INVENTION

The robots used in an environment with high hygienic requirements, e.g. in the food sector, in the medical or pharmaceutical sector or the like, are specially constructed robots, which must in turn satisfy the increased hygiene requirements made on the environment. It is known to equip robots suitable for such uses with a casing made from an inert and easily cleanable or disinfectable material such as e.g. stainless steel, or provided with a special coating or paint. They require the use of cost-intensive, ecological lubricants or, when using conventional lubricants such as mineral oils, additional sealing means in order to reliably prevent an escape of lubricant from the robot, thereby contaminating the environment. As such robots are special designs, which are only manufactured in small numbers, they are on the one hand only obtainable in a few design variants, e.g. with respect to kinematics, carrying capacity, operating area, etc., whilst on the other, more particularly due to the use of special materials, they are very expensive. The latter more particularly applies to spares and wearing parts, as well as working materials and substances such as e.g. lubricants, which must be kept in stock.

Therefore the problem of the invention, whilst avoiding the aforementioned disadvantages, is to provide an inexpensive robot, which is universally usable in an environment with increased hygienic requirements.

### SUMMARY OF THE INVENTION

According to the invention this problem is solved with a robot of the aforementioned type, which is characterized by an envelope surrounding it in a substantially gas and liquid-tight manner, which has a flexible construction at least on a section facing the robot hand and at least partly exposes a tool, thereby sealing the engaging on the transition area from the robot hand.

The envelope according to the invention, which surrounds the robot in gas and liquid-tight manner on the one hand prevents contamination of the environment by the robot, e.g. through lubricants passing out of the robot, abrasion of seals, etc. and on the other prevents damage to the robot by detergents, disinfectants, etc. It completely surrounds the robot with the exception of its tool and it preferably sealingly engages all round the same with an area surrounding the robot hand and at least in the area of the robot hand or the entire robot arm has a flexible construction so as to permit unrestricted robot movements. Apart from the envelope, the robot requires no further cost-intensive measures in order to allow its use in an environment with increased hygienic requirements. This permits the use of random, conventional robots, which only have to be provided with a corresponding envelope according to the invention.

According to a preferred construction a detachable connection is provided between the envelope area surrounding the robot hand and the remaining envelope, which is e.g. constructed as a substantially gas and liquid-tight zip or Velcro fastener or can have a lip seal. It is also possible to provide clamping means such as e.g. straps, clips, etc., in order to fasten or tie the residual envelope to the robot in the vicinity of the detachable envelope. This permits an easy replacement of the robot or envelope, which is particularly advantageous in the case of robot maintenance or repairs. Simultaneously a single envelope can be used for different robot types.

The envelope is preferably at least partly transparent in order to be able to visually monitor robot operation.

According to a preferred construction, the envelope is constructed in the manner of a cabin receiving at least the robot frame and having at least one passage for the robot arm and a membrane, the passage being connected around its circumference to the flexible membrane in a substantially gas and liquid-tight manner. According to this construction at least the robot base is housed in the cabin, whereas the robot arm with the robot hand passes through the passage and the flexible membrane connecting the robot hand circumference with the passage circumference seals the interior of the cabin with respect to the environment and ensures the necessary freedom of movement for the robot arm or hand.

The cabin appropriately has a smooth, easily cleanable and disinfectable outer surface and can e.g. be provided with slopes and/or channels facilitating the draining off of detergents or disinfectants.

In a preferred construction, there is a detachable connection between the passage and the membrane, which is constructed e.g. corresponding to the detachable connection between the envelope area surrounding the robot hand and the residual envelope in the form of a Velcro or zip fastener and can have a lip seal or clamping means, such as straps, clips, etc.

Preferably the robot frame is placed on a base plate forming the top or bottom of the cabin and the passage is located on at least one cabin side wall.

The cabin is preferably of the walk-in type, so that the robot is readily accessible. In the case of a walk-in cabin, the latter preferably receives the robot control device. Preferably the cabin has at least one window and the cabin side walls are at least partly transparent, being made e.g. from glass, plexiglass, etc.

The flexible membrane tightly engaging on the robot hand is made either from an expansible material, such as an elastomeric plastic sheet and is clamped between the cabin passage and the robot hand, or the membrane is made from a non-expansible or only slightly expansible material, such as a thermoplastic sheet or coated textiles and is folded, gathered up, etc. between the passage and the robot hand.

The invention also relates to an envelope for a multiaxial robot with at least one of the aforementioned features.

### BRIEF DESCRIPTION OF THE DRAWINGS

The invention is described hereinafter relative to a preferred embodiment and with reference to the single drawing, which is a perspective view of a multiaxial robot with an envelope constructed in the manner of a cabin.

### DETAILED DESCRIPTION OF THE DRAWING

The multiaxial robot 1 shown in the drawing comprises a frame 2 placed on a base plate 7 and a carrousel 3 pivotable about a base axis 5 and placed on the frame 2. On the carrousel 3 is placed by means of a rocker arm 3a a robot arm 4, pivotable about several axes and having a robot hand 6, to which is fixed a tool 8. The robot 1 is a random, conventional robot, which is not suitable for use in an environment 22 having increased hygienic requirements. The robot 1 can also have a random, differing construction, whilst there are also a random number and design of the robot axes.

To permit universal use of the robot 1 in the environment 2 with increased hygienic requirements, said robot is provided with an envelope 10, which has a cabin 20, which receives the frame 2, the carrousel 3 located on the frame 2 and the base of the robot arm 4.

In the represented construction the cabin 20 has a substantially parallelepipedic construction, the robot base plate 7 simultaneously forming the bottom or floor of the cabin 20. The cabin 20 has side walls 12 provided with windows 13, a side wall 12b provided with a door 14 for entering the interior 21 of the cabin 20 and a side wall 12a facing the side wall 12b. The side wall 12a contains a passage 18 for the robot arm 4 and around its circumference is placed a flexible membrane 11, which insulates the interior 21 of the cabin 20 in gas and liquid-tight manner from the environment 22. The cabin 20 is made from an inert, smooth and easily cleanable material, e.g. stainless steel, plastic or the like, or is coated with one of these materials. The cabin roof 15 is e.g. inclined in order to permit drainage of detergents or disinfectants. The cabin 20 also receives a control device 16 in the manner of a control cabinet for the robot 1.

In the represented construction the membrane 11 is made from an expansible material, e.g. an elastomeric plastic sheet and is braced between the passage 18 in the side wall 12a of the cabin 20 and the robot hand 6. The robot hand 6 is closely surrounded by an area 10a separable from the residual envelope or the membrane 11. To ensure separability it is possible to provide between said area 10a and the membrane 11 a detachable connection 9, e.g. a gas and liquid-tight zip fastener, which permits an easy replacement of the robot or parts thereof. To be able to remove from the cabin 20 the completely installed robot 1, the windows 13 can be constructed e.g. in hinged manner or as doors.

The envelope 20 according to the invention prevents any contamination of the environment 22 by the robot 6 and also any damage of robot 6 by substances used in the environment 22 such as detergents or disinfectants. It in particular allows the use of conventional robots 1 in an environment 22 with increased hygienic requirements and therefore renders disposable the use of complicated and expensive special robots.

1. Multiaxial robot (1) with a frame (2), a structure with at least one robot arm (4) having a robot hand (6) and an envelope (10) surrounding in substantially gas and liquid-tight manner the robot (1) and more particularly intended for use in the food sector, characterized in that the envelope (10) has a cabin (20) at least receiving the frame (2) of the robot (10 and provided with at least one passage (18) for the robot arm (4) and a flexible membrane (11), the passage (18) about its circumference being connected in substantially gas and liquid-tight manner to the membrane (11) and at least partly exposes a tool (8), whilst the membrane (11) sealingly engages on the transition area from the robot hand (6) to the tool (8).

2. Robot according to claim 1, characterized in that an area (10a) of the envelope (10) surrounding the robot hand (6) sealingly engages on the latter.

3. Robot according to claim 2, characterized in that there is a detachable connection (9) between the area (10a) and the membrane (11).

4. Robot according to claim 3, characterized in that the connection (9) between the area (10a) and the membrane (11) is constructed as a substantially gas and liquid-tight zip or Velcro fastener.

5. Robot according to claim 3, characterized in that the connection (9) between the area (10a) and the membrane (11) has a lip seal.

6. Robot according to claim 3, characterized in that the connection (9) between the area (10a) and the membrane (11) has a clamping means such as a strap, a clip or the like.

7. Robot according to claim 1, characterized in that the envelope (10) is at least partly transparent.

8. Robot according to claim 1, characterized in that there is a detachable connection (19) between the passage (18) and the membrane (11).

9. Robot according to claim 8, characterized in that the connection (19) between the passage (18) and the membrane (11) is constructed as a substantially gas and liquid-tight zip or Velcro fastener.

10. Robot according to claim 8, characterized in that the connection (19) between the passage (18) and the membrane (11) has a lip seal.

11. Robot according to claim 8, characterized in that the connection (19) between the passage (18) and the membrane (1) has a clamping means such as a strap, a clip or the like.

12. Robot according to claim 1, characterized in that the frame (2) of the robot (1) is placed on the base plate (7) forming the top or bottom of the cabin (20).

13. Robot according to claim 1, characterized in that the passage (18) is located on at least one side wall (12a) of the cabin (20).

14. Robot according to claim 1, characterized in that the cabin (20) is of the walk-in type.

15. Robot according to claim 14, characterized in that the cabin (20) receives a control device (16) for the robot (1).

16. Robot according to claim 1, characterized in that the cabin (20) has at least one window (13).

17. Robot according to claim 1, characterized in that the membrane (11) is made from an expansible material.

18. Robot according to claim 17, characterized in that the membrane (11) is braced between the passage (18) and the robot hand (6).

19. Robot according to claim 17, characterized in that the membrane (11) is made from an elastomeric plastic sheet.

20. Robot according to claim 1, characterized in that the membrane (11) is made from a non-expansible or only slightly expansible material and is gathered up between the passage (18) and the robot hand (6).

21. Robot according to claim 20, characterized in that the membrane (11) comprises a thermoplastic sheet.

22. Robot according to claim 20, characterized in that the membrane (11) comprises coated textiles.

23. Envelope for a multiaxial robot (1), characterized by the features of at least one of the claims 1 to 22.
